(19) United States
(12) Patent Application Publication
(10) Pub. No.: US 2009/0158214 A1
(43) Pub. Date: Jun. 18, 2009

(54) System, Method, Apparatus and Computer Program Product for Providing Presentation of Content Items of a Media Collection

(75) Inventors: Steve Arnold, Yateley (GB); Toni Strandell, Helsinki (FI); Jukka-Pekka Salmenkaita, Helsinki (FI); Elina Vartiainen, Helsinki (FI); Janne Kaasalainen, Helsinki (FI); Tuomas Vaittinen, Helsinki (FI); Timo-Pekka Viljamaa, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/955,814

(22) Filed: Dec. 13, 2007

(51) Int. Cl. G06F 3/048

(52) U.S. Cl. 715/830

(57) ABSTRACT

An apparatus for providing presentation of content items of a media collection may include a processing element. The processing element may be configured to provide for a rendering of a content item having at least a first attribute and a second attribute, enable a user to access other content items related to the content item by the first attribute using a first scrolling function oriented with respect to a first axis, and enable the user to access further content items related to the content item by the second attribute using a second scrolling function oriented with respect to a second axis.

### TECHNOLOGICAL FIELD

Embodiments of the present invention relate generally to content management technology and, more particularly, relate to a system, method, device, mobile terminal and computer program product for providing presentation of content items of a media collection.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content and/or receive content relatively quickly upon request, and given also that mobile electronic devices such as mobile phones often face limitations in display size, text input speed, and physical embodiments of user interfaces (UI), challenges are created in content management. Specifically, an imbalance between the development of capabilities related to storing and/or accessing content and the development of physical UI capabilities may be perceived.

An example of the imbalance described above may be realized in the context of content management and/or selection. In this regard, for example, if a user has a very large amount of content stored in electronic form, it may be difficult to sort through the content in its entirety either to search for content to render or merely to browse the content. This is often the case because content is often displayed in a one dimensional list format. As such, only a finite number of content items may fit in the viewing screen at any given time. Scrolling through content may reveal other content items, but at the cost of hiding previously displayed content items.

In order to improve content management capabilities, metadata or other tags may be automatically or manually applied to content items in order to describe or in some way identify a content item as being relevant to a particular subject. As such, each content item may include one or more metadata tags that may provide a corresponding one or more relevancies with which the corresponding content item may be associated. Thus, for some content, such as, for example, a gallery of pictures, a grid or list of content items may be displayed based on the metadata. However, even when a gallery of content items is displayed, it is common for the contents of the gallery or the list to be arranged based on a single criteria (or a single metadata tag) such as date, location, individual creating or in the content item, genre, album, artist, and so on.

Users may desire an opportunity to more easily review their content in a manner that permits a seamless shift between content related to different topics of subjects. For example, before the advent of devices enabling the viewing of digital photographs by browsing through thumbnail images, a physical folder, album, or even a shoebox full of pictures may have been sorted through during a search for a particular picture. However, while sorting through the pictures for the particular picture, other related (or even unrelated) photographs may be encountered that might add to the user's enjoyment of the search or even take the user in a different direction than originally intended. Such an experience may be hard to duplicate given the current state of searching and browsing technology.

Although a user may select a different criteria to serve as the basis for the list or gallery of content items, or to serve as the basis for scrolling between content items (e.g., in a grid), the selection of the different criteria typically requires excessive user interface. In this regard, for example, the user may be required to access a separate menu for selection of a new criteria. Additionally or alternatively, the user may be required to type in a text identifier of the new criteria. Accordingly, users may perceive the selection of the different criteria to be an impediment to effectively and efficiently browsing their content. Thus, only a minimal or at least partial portion of a collection of content items may be browsed, played or utilized. This may be true whether the collection relates to music, movies, pictures or virtually any type of content.

Thus, it may be advantageous to provide an improved method of presenting content items of a media collection, which may provide improved content management for operations such as searching, browsing, playing, editing and/or organizing content.

### BRIEF SUMMARY

A system, method, apparatus and computer program product are therefore provided to enable presentation of content items of a media collection. In particular, a method, apparatus and computer program product are provided that may enable the rendering of a content item having at least a first feature and a second feature such that a user may access other content items related to the content item by the first feature using a first scrolling function and may access further content items related to the content item by the second feature using a second scrolling function. In an exemplary embodiment, content items related to the content item being rendered by sharing a first metadata tag or other feature may be accessed, for example, by scrolling horizontally to the left or to the right. Meanwhile, content items related to the content item being rendered by sharing a second metadata tag or other feature may be accessed, for example, by scrolling vertically up or down. In this regard, for example, the user may be viewing content related to a first theme, topic or subject (e.g., the first metadata tag or feature) and shift to viewing content that is related to a different theme, topic or subject (e.g., a different metadata tag or feature) by simply selecting a scroll function in a direction different than the direction designated for viewing content of the original or first theme, topic or subject. In an exemplary embodiment, each content item may have associated metadata corresponding to one or more of various attributes that may be used for organization and display of the content. In one embodiment, the content may then be sorted and displayed or rendered relative to defined axes on the basis of various different attributes, metadata tags or features. Accordingly, the efficiency of content display, sorting, selection, editing, etc. may be increased and content management for devices such as mobile terminals may be improved. Additionally, an element of randomness may be added to increase the enjoyment of the user by potentially introducing content that may be of interest although the content is unrelated to the specific content for which a search is being conducted.

Embodiments of the invention may provide a method, apparatus and computer program product for advantageous employment in content management environments including a mobile electronic device environment, such as on a mobile terminal capable of creating and/or viewing content items and objects related to various types of media. As a result, for example, mobile terminal users may enjoy an improved content management capability and a corresponding improved ability to select and experience content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing presentation of content items of a media collection according to an exemplary embodiment of the present invention;

FIG. 4 illustrates an example of a display generated according to an exemplary embodiment of the present invention;

FIG. 5 illustrates another example of a display generated according to an exemplary embodiment of the present invention;

FIG. 6 illustrates still another example of a display generated according to an exemplary embodiment of the present invention;

FIG. 7 illustrates an example of the display of FIG. 6 as modified by the selection of another content item according to an exemplary embodiment of the present invention;

FIG. 8 illustrates another example of a display generated to include a plurality of axes according to an exemplary embodiment of the present invention;

FIG. 9 illustrates an example of a display generated according to an exemplary embodiment of the present invention;

FIG. 10 illustrates another example of a display generated according to an exemplary embodiment of the present invention;

FIG. 11 illustrates an exemplary display including a content pool according to an exemplary embodiment of the present invention; and

FIG. 12 is a flowchart according to an exemplary method for providing presentation of content items of a media collection according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

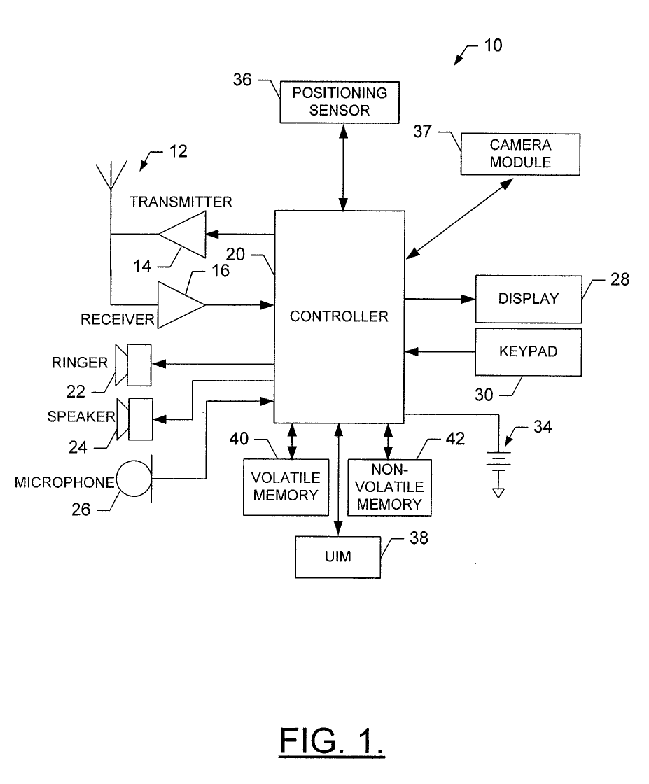

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, positioning (GPS) devices, internet devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP), File Transfer Protocol (FTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

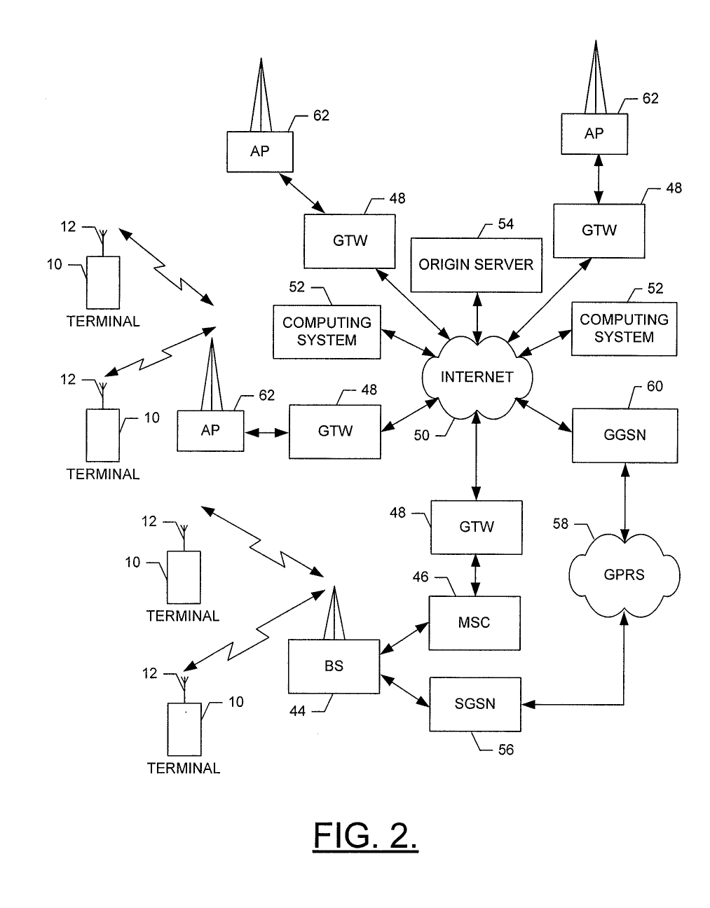

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

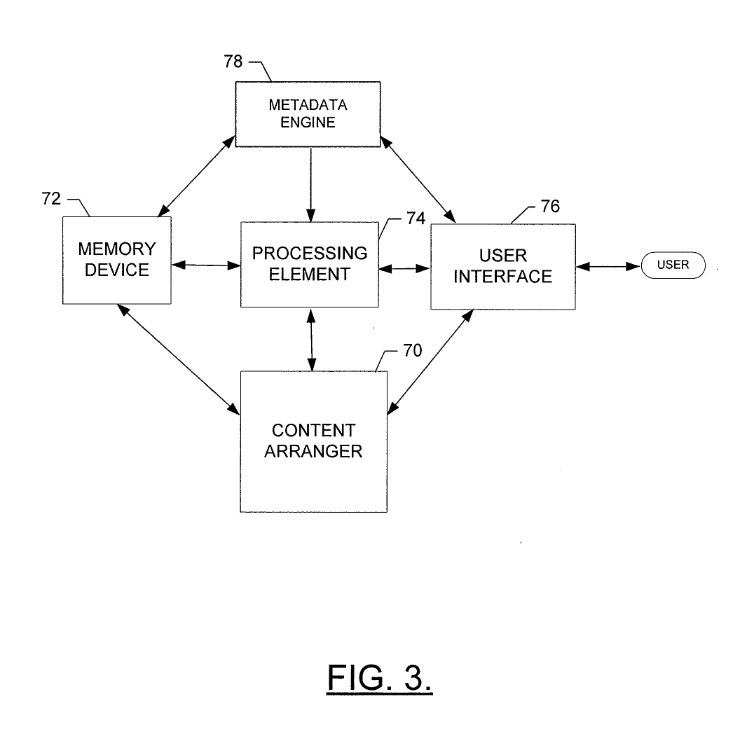

An exemplary embodiment of the invention will now be described with reference to FIG. 3, in which certain elements of a system for providing presentation of content items of a media collection are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. In this regard, for example, a user of a personal computer may enjoy browsing content using embodiments of the present invention due to the ability provided by embodiments of the present invention to switch between viewing content items on the basis of one or more different themes. As an example of devices other than the mobile terminal of FIG. 1, the system of FIG. 3 may be employed on a personal computer, a camera, a video recorder, a handheld computer, a server, a proxy, etc. Alternatively, embodiments may be employed on a combination of devices including, for example, those listed above. It should also be noted that while FIG. 3 illustrates one example of a configuration of a system for providing presentation of content items of a media collection, for example, in a metadata-based content management environment, numerous other configurations may also be used to implement embodiments of the present invention and attributes or features other than metadata may form the basis for content management and presentation according to embodiments of the present invention. As such, it should be noted that the devices or elements described below may not be mandatory and thus some may be omitted in certain embodiments.

Referring now to FIG. 3, a system for providing presentation of content items of a media collection is provided. The system may be embodied in hardware, software or a combination of hardware and software for use by a device such as the mobile terminal 10. The system may include a content arranger 70, a memory device 72, processing element 74 and a user interface 76. In exemplary embodiments, the content arranger 70, the memory device 72, the processing element 74 and the user interface 76 may be in communication with each other via any wired or wireless communication mechanism. In this regard, for example, the user interface 76 may be in communication with at least the content arranger 70 and/or the processing element 74 to enable the content arranger 70 to generate a display of or otherwise render content stored in the memory device 72 based, for example, on metadata associated with the content. For example, a user may utilize the user interface 76 in order to direct the operation of a device (e.g., the mobile terminal 10) to import a file such as a multimedia file, capture an image or an audio/video sequence, download web content, create or download data or a document, etc., to thereby create a content item, which may have associated metadata and/or other attributes or features that can be used to organize the content item for display or rendering such that other content items may be accessed via scrolling function based at least in part on the associated metadata in accordance with embodiments of the present invention as described in greater detail below. In an exemplary embodiment, the content item could be, for example, content processed according to a lossy or lossless audio, video or graphic compression technique. As such, for example, a free lossless audio code (FLAC), Moving Picture Experts Group-1 Audio Layer-3 (MP3) and numerous other types of audio compression techniques may be employed for content items according to embodiments of the present invention. Alternatively, the content item could be various types of media or textual content. For example, the content item could be an email or text message. As such, embodiments of the present invention may be utilized for sorting and browsing media and/or documents, emails, text messages, etc.

Embodiments of the present invention could also be used to browse content (e.g., bookmarks (such as bookmarks that have tags), content provided by social networking/recommendation sites, etc.). For example, if a user is playing a song by a particular artist, a plug-in may be provided that connects to an exemplary recommendation service. Accordingly, a list of artists related to the particular artist (e.g., either by tag, style, RIYL (recommended if you like), etc.) may be presented along other axes. Embodiments could also be used for phone book or calendar navigation. Accordingly, for example, different axes may be provided to correspond to different category entries such as a category entry for all contacts using the same instant messenger (IM) (e.g. msn, skype, yahoo messenger, google talk, etc.), postal address, name/phone number, protocol notes, pictures, presence (e.g., IM related) and so on. A category entry could also be indicative of frequency of use (e.g., how often a user calls or texts someone), etc.

It should be noted that any or all of the content arranger 70, the memory device 72, the processing element 74 and the user interface 76 may be collocated in a single device. For example, the mobile terminal 10 of FIG. 1 may include all of the content arranger 70, the memory device 72, the processing element 74 and the user interface 76. Alternatively, any or all of the content arranger 70, the memory device 72, the processing element 74 and the user interface 76 may be disposed in different devices. For example, the content arranger 70, the processing element 74 and/or the memory device 72 may be disposed at a server, while the user interface 76 may be disposed at a mobile terminal in communication with the server. Other configurations are also possible. In other words, embodiments of the present invention may be executed in a client/server environment as well as or instead of operation on a single device. As such, for example, in an embodiment where the memory device 72 is located at a server, the mobile terminal 10 may view content sorted and presented based on metadata stored or otherwise accessible to the mobile terminal 10 while the content associated with the metadata is actually stored at the memory device of the server. Thus, upon selection of a particular content item at the mobile terminal 10, the particular content item may be streamed, downloaded or otherwise communicated to the mobile terminal from the server.

In an exemplary embodiment, the system may also include a metadata engine 78, which may be embodied as or otherwise controlled by the processing element 74. The metadata engine 78 may be configured to assign metadata to each created object for storage in association with the created content item in, for example, the memory device 72. In an exemplary embodiment, the metadata engine 78 may be in simultaneous communication with a plurality of applications and may generate metadata for content created by each corresponding application. Examples of applications that may be in communication with the metadata engine may include, without limitation, multimedia generation, phonebook, document creation, calendar, gallery, messaging client, location client, calculator and other like applications. Alternatively, or additionally, content may be received from other devices by file transfer, download, or any other mechanism, such that the received content includes corresponding metadata.

The metadata engine 78 may be any device or means embodied in either hardware, software, or a combination of hardware and software configured to generate metadata according to a defined set of rules. The defined set of rules may dictate, for example, the metadata that is to be assigned to content created using a particular application or in a particular context, etc. As such, in response to receipt of an indication of event such as taking a picture or capturing a video sequence (e.g., from the camera module 37), the metadata engine 78 may be configured to assign corresponding metadata (e.g., a tag). The metadata engine 78 may alternatively or additionally handle all metadata for the content items, so that the content items themselves need not necessarily be loaded, but instead, for example, only the metadata file or metadata entry/entries associated with the corresponding content items may be loaded in a database.

Metadata typically includes information that is separate from an object, but related to the object. An object may be “tagged” by adding metadata to the object. As such, metadata may be used to specify properties, features, attributes, or characteristics associated with the object that may not be obvious from the object itself. Metadata may then be used to organize the objects to improve content management capabilities. Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content is defined as “created” whenever the content first becomes resident in a device, by whatever means regardless of whether the content previously existed on other devices. However, some context metadata may also be related to the original creation of the content at another device if the content is downloaded or transferred from another device. Context metadata can be associated with each content item in order to provide an annotation to facilitate efficient content management features such as searching and organization features. Accordingly, the context metadata may be used to provide an automated mechanism by which content management may be enhanced and user efforts may be minimized.

Metadata or tags are often textual keywords used to describe the corresponding content with which they are associated, but the metadata can in various embodiments be any type of media content. In various examples, the metadata could be static in that the metadata may represent fixed information about the corresponding content such as, for example, date/time of creation or release, context data related to content creation/reception (e.g., location, nearby individuals, mood, other expressions or icons used to describe context such as may be entered by the user, etc.), genre, title information (e.g., album, movie, song, or other names), tempo, origin information (e.g., artist, content creator, download source, etc.). Such static metadata may be automatically determined, predetermined, or manually added by a user. For example, a user may, either at the time of creation of the content, or at a later time, add or modify metadata for the content using the user interface 76. In some embodiments, user added metadata or tags may form a rich source of determining attributes upon which to base content organization since the user tags may be likely to indicate real relationships that may be appreciated by the user.

Alternatively, the metadata could be dynamic in that the metadata may represent variable information associated with the content such as, for example, the last date and/or time at which the content was rendered, the frequency at which the content has been rendered over a defined period of time, popularity of the content (e.g. using sales information or hit rate information related to content), ratings, identification of users with whom the content has been shared, who has viewed or recommended the content or designate the content as a favorite, etc. In an exemplary embodiment, popularity of the content could further include feedback, comments, recommendations, etc. that may be determined either implicitly or explicitly, favorite markings or other indications of user satisfaction related to a content item that may be gathered from various sources such as via the Internet, radio stations, or other content sources. Explicit feedback may be determined, for example, from written survey responses, blog comments, peer-to-peer recommendations, exit polls, etc. Implicit feedback may be determined based on user responses to particular content items (e.g., lingering on a content item, number of hits, multiple viewings or renderings, purchasing the content item, etc.). Title information and/or origin information may be displayed, for example, in alphabetical order. Date/time related information may be presented in timeline order. Frequency, popularity, ratings, tempo and other information may be presented on a scale from infrequent to frequent, unpopular to popular, low to high, slow to fast, respectively, or vice versa.

The memory device 72 (e.g., the volatile memory 40 or the non-volatile memory 42) may be configured to store a plurality of content items and associated metadata and/or other information (e.g., other attribute or feature information) for each of the content items. The memory device 72 may store content items of either the same or different types. In an exemplary embodiment, different types of content items may be stored in separate folders or separate portions of the memory device 72. However, content items of different types could also be commingled within the memory device 72. For example, one folder within the memory device 72 could include content items related to types of content such as movies, music, broadcast/multicast content (e.g., from the Internet and/or radio stations), images, video/audio content, etc. Alternatively, separate folders may be dedicated to each type of content.

In an exemplary embodiment, a user may utilize the user interface 76 to directly access content stored in the memory device 72, for example, via the processing element 74. The processing element 74 may be in communication with or otherwise execute an application configured to display, play or otherwise render selected content via the user interface 76. However, as described herein, navigation through the content of the memory device 72 may be provided by the content arranger 70 as described in greater detail below.

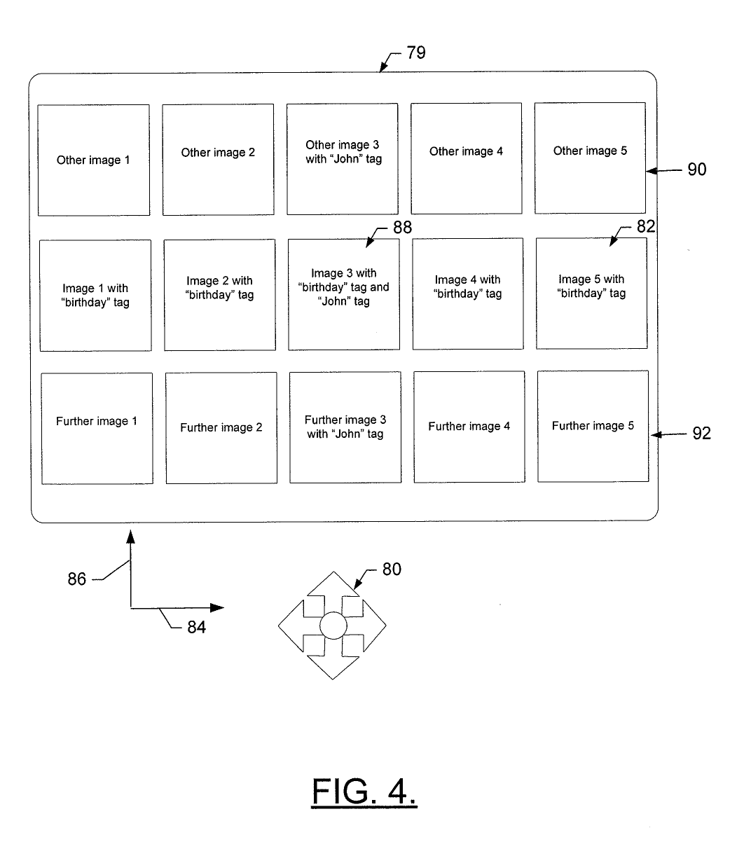

The user interface 76 may include, for example, the keypad 30 and/or the display 28 and associated hardware and software. It should be noted that the user interface 76 may alternatively be embodied entirely in software, such as may be the case when a touch screen is employed for interface using functional elements such as software keys accessible via the touch screen using a finger, stylus, etc. Alternatively, proximity sensors may be employed in connection with a screen such that an actual touch need not be registered in order to perform a corresponding task. Speech input could also or alternatively be utilized in connection with the user interface 76. As another alternative, the user interface 76 may include a simple key interface including a limited number of function keys, each of which may have no predefined association with any particular text characters. As such, the user interface 76 may be as simple as a display and one or more keys for selecting a highlighted option on the display for use in conjunction with a mechanism for highlighting various menu options on the display prior to selection thereof with the one or more keys. For example, the key may be a five way scroller 80 (e.g., a scroll device capable of receiving four directional inputs such as up/down, right/left and a selection input) as shown in FIG. 4 although a scroll device with any number of directional input possibilities may be used. User instructions for the performance of a function may be received via the user interface 76 and/or an output such as by visualization, display or rendering of data may be provided via the user interface 76.

The content arranger 70 may be embodied as any device or means embodied in either hardware, software, or a combination of hardware and software that is capable of performing the corresponding functions of the content arranger 70 as described in greater detail below. In an exemplary embodiment, the content arranger 70 may be controlled by or otherwise embodied as the processing element 74 (e.g., the controller 20 or a processor of a computer or other device). Processing elements such as those described herein may be embodied in many ways. For example, the processing element may be embodied as a processor, a coprocessor, a controller or various other processing means or devices including integrated circuits such as, for example, an ASIC (application specific integrated circuit).

In an exemplary embodiment, the content arranger 70 may be configured to receive an input, for example, via the user interface 76 defining a first attribute (e.g., a metadata tag). Attributes such as the first attribute may define properties, features or characteristics which may correlate to metadata associated with each content item. For example, attributes may include information such as date and/or time of creation or release, tempo, genre, title or origin information, an identity of a creator of the content or of an entity associated with the content, an event or location associated with the content, the last date and/or time at which the content was rendered, the frequency at which the content has been rendered over a defined period of time, popularity of the content, etc. Attributes could describe any feature of a content item such as, for example, origin, filename, size, etc. Moreover, the attributes may be internally or externally generated. Thus, for example, information on popularity of content items (e.g., a top 20 albums listing) may be received from an external source and each content item may be assigned an attribute indicative of its popularity (e.g., its ranking). The content arranger 70 may then be configured to arrange content for display or rendering such that a scrolling function may provide access from one content item to the next based on scrolling between content items sharing the first attribute. In an exemplary embodiment, content items sharing the first attribute (e.g., pictures having the same metadata tag such as “birthday”) may be displayed on a grid having a first axis corresponding to the first attribute and including a plurality of content items. In other words, a set of the plurality of content items that are each associated with the first attribute may be displayed on a single column or row of content items and may be accessed by scrolling in the direction of the first axis (e.g., in a horizontal or vertical direction). Alternatively, even though an arrangement of multiple content items may be defined in order to enable scrolling from one content item to the next on the basis of the first attribute by scrolling in a first direction, no grid need necessarily be displayed. Rather, only a single content item may be displayed despite the fact that a grid-like arrangement defining the relationship of other content items accessible via the scrolling function may be defined. Alternatively, no grid-like arrangement need be defined and instead only links from one content item to a next may be defined on the basis of the first attribute.

In an exemplary embodiment, the content arranger 70 may also be configured to enable the user to access further content items related to a particular content item on the basis of a second attribute associated with the particular content item. In this regard, for example, the content arranger 70 may be configured to provide a mechanism by which to access another attribute (e.g., the second attribute) associated with a currently displayed content item. The second attribute may then form the basis upon which scrolling to find related content may be accomplished. For example, scrolling in a different direction than the direction used to scroll content on the basis of the first attribute may provide an ability to select the second attribute (or another content item related to the currently displayed content item based on the second attribute) or may define the second attribute so that content items may be arranged based on the second attribute rather than based only on the first attribute. As such, the content arranger 70 may be configured to enable the user to access further content items related to the particular content item based on the second attribute using a second scrolling function oriented with respect to a second axis corresponding to the second attribute.

For example, as shown in FIG. 4, which illustrates an example of a display 79 generated according to an exemplary embodiment of the present invention, “birthday” may be selected as the first attribute along a horizontal or X-axis 84. Thus, using a five way scroller 80 to scroll to the right or left along the X-axis 84 may provide selection of another content item 82 that shares the “birthday” attribute or metadata tag as a particular content item 88. Meanwhile, for any given content item, such as the particular content item 88, which may include a second attribute (or additional attributes), scrolling along the vertical or Y-axis 86 may provide for the selection of the second attribute or at least for enabling access to a plurality of content items sharing the second attribute (e.g., “John”). Thus, in the example shown in FIG. 4, scrolling along the X-axis 84 may enable access to content items having the metadata tag “birthday”, while, at least with respect to the particular content item 88, scrolling along the Y-axis 86 may enable access to further content items having the metadata tag “John”. Thus, the particular content item 88 may include both the metadata tags “birthday” and “John” and may be considered a bridge between some otherwise unrelated content items that include either the “birthday” or “John” metadata tag. In an exemplary embodiment, the particular content item 88 may represent a currently selected or highlighted content item.

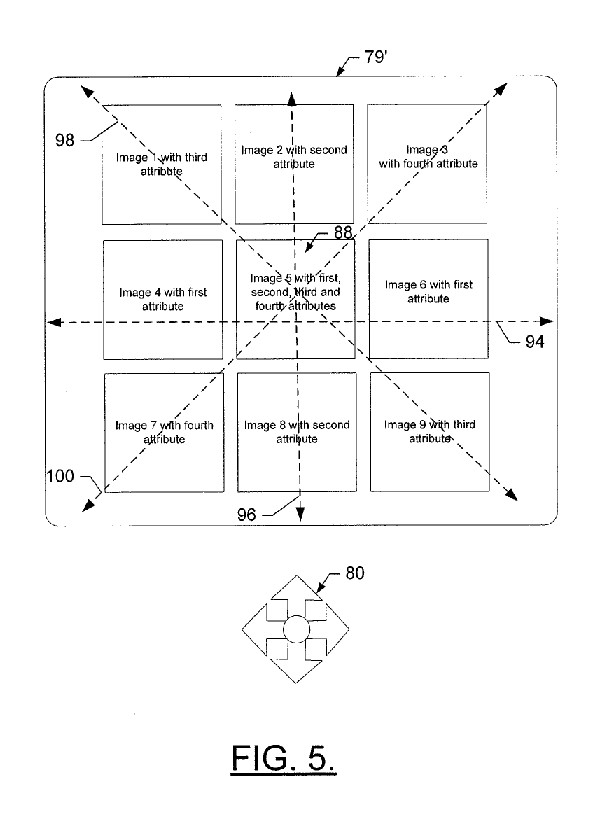

As shown in FIG. 4, content items in the same row as the particular content item 88 (i.e., aligned with the particular content item 88 with respect to a first axis such as the X-axis 84) may each share the attribute “birthday”. Furthermore, content items in the same column as the particular content item 88 (i.e., aligned with the particular content item 88 with respect to a second axis such as the Y-axis 86) may each share the attribute “John”. In an exemplary embodiment, additional content items displayed in rows parallel to the X-axis 84 may also share a particular feature or attribute with other content items in the corresponding row. For example, content items in a top row 90 may each share a particular attribute such as having a common creator of the corresponding content items while content items of a bottom row 92 may each share a particular attribute such as organization in order of time and date of creation or another attribute. Accordingly, by scrolling along the X-axis 84, the user may view other content items that are related to a currently selected or highlighted content item by sharing a first attribute, whereas scrolling along the Y-axis 86 may enable the user to switch to a different attribute (e.g., the second attribute). In this exemplary embodiment, continued scrolling along the Y-axis 86 may enable the user to view other content items sharing the second attribute. However, other embodiments, such as the embodiment shown in FIG. 5, may provide for yet another change in attribute each time a scroll occurs along a different direction than the direction associated with scrolling content sharing the first attribute.

In this regard, FIG. 5 illustrates an example of a display 79′ generated according to another exemplary embodiment of the present invention. It should be noted that although FIG. 5 illustrates a three-by-three grid of images, other types of content items and other sizes of grids may be displayed. As shown in FIG. 5, four different axes (e.g., first axis 94, second axis, 96, third axis 98 and fourth axis 100) may be defined in association with the three-by-three grid (and of course, with additional images, additional axes may be provided). Each of the four different axes may be associated with a corresponding different attribute (e.g., a first attribute, a second attribute, a third attribute and a fourth attribute). However, as an alternative, each axis could correspond to two different attributes, with the origin being a dividing line between the two different attributes associated with each axis. As such, for example, if one attribute is associated with each axis as shown in FIG. 5, starting from the particular content item 88, the user may scroll over content items sharing the first attribute by scrolling along the first axis 94 and the user may scroll over content items sharing the second attribute by scrolling along the second axis 96. Each time a scroll operation is conducted and a new content item is selected or highlighted, the selected or highlighted content item may move to the position of the particular content item 88 (e.g., to the center of the grid) and the grid may be modified or updated based on the features or attributes associated with the selected or highlighted content item. However, in an alternative embodiment, the grid may be fixed and navigation between items of the grid may not alter the arrangement of the grid.

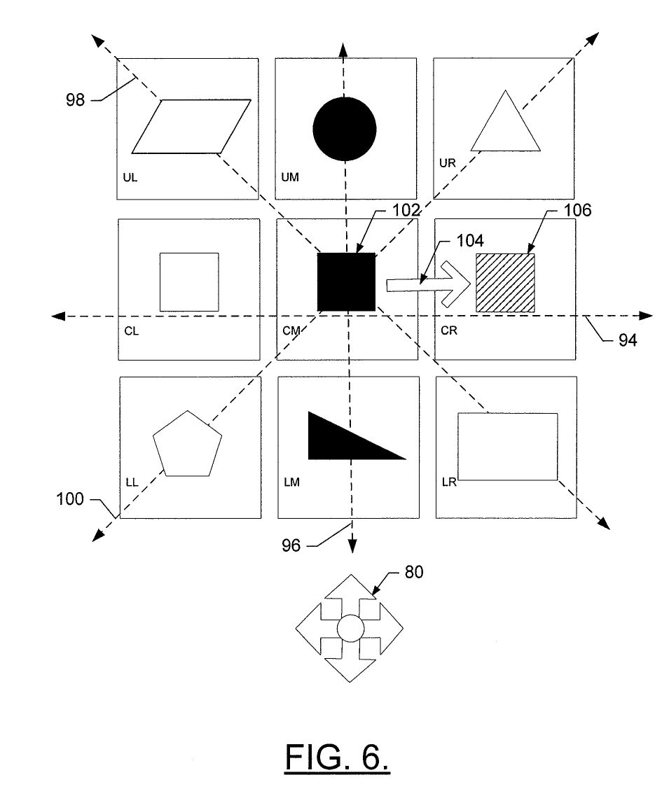

As an example, as shown in FIG. 6, which illustrates a general grid layout for a three-by-three grid, if a first selected content item 102 was initially located in the center of the grid at position CM (center row, middle column), and the user scrolls to the right as indicated by arrow 104, the content item (e.g., second selected content item 106) formerly positioned at the CR position (center row, right column) may be shifted to the CM position and the first selected content item 102 may be shifted to the CL (center row, left column) position. The remaining content items (e.g., those items in the UL (upper row, left column), UM (upper row, middle column), UR (upper row, right column), LL (lower row, left column), LM (lower row, middle column) and LR (lower row, right column) positions) may each be updated based on other attributes of the second selected content item 106 such that content items are arranged along each axis based on a corresponding attribute associated with each axis. Alternatively, the remaining content items may each stay in the same position.

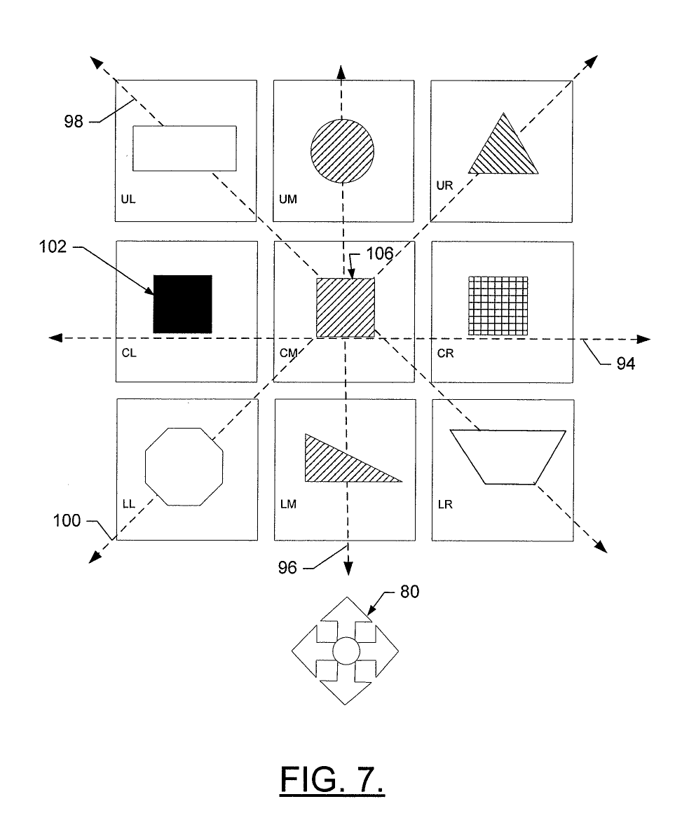

FIG. 7 illustrates the display of FIG. 6 generated after the selection of the second selected content item 106. As indicated in FIG. 6, in which each of the four axes corresponds to a particular attribute of the first selected content item 102, which is a black filled square, content items along the first axis 94 may each share an attribute of being squares. Content items along the second axis 96 may each share an attribute of being black filled objects. Content items along the third axis 98 may each share an attribute of being four sided objects. Content items along the fourth axis 100 may each share an attribute of being regular shapes. Meanwhile, when the second selected content item 106 is selected as shown in FIG. 7, different objects may be displayed in the upper and lower rows based on features associated with the second selected content item 106, while content items of the center row merely shift to accommodate the movement of the second selected content item 106 to the CM position. As such, a new content item sharing the first attribute may be moved into the CR position and the first selected content item 102 is moved to the CL position. However, it should be noted that, for example, content items associated with any given attribute may be continuously wrapped such that continued scrolling along the first axis may result in a repeat of the content items displayed at some point. Thus, if there were only three content items associated with the first attribute, movement of the second selected content item 106 to the CM position may result in the wrapping of objects such that the object formerly in the CL position may move to the CR position.

It should also be noted that although attributes related to shapes form the basis for arrangement of the objects of FIGS. 6 and 7, the basis for the arrangement could alternatively be metadata or other features associated with any particular content item. Thus, the shapes of FIGS. 6 and 7 are merely used for exemplary purposes and not for purposes of limitation. Additionally, although the same attributes are associated with each axis in FIGS. 6 and 7 following the selection of the second selected content item 106, the attributes associated with each axis other than the axis in which the scrolling function occurred may be changed with the selection of each subsequent content item. In such a situation, the new attributes may depend upon attributes associated with the newly selected content item.

In an exemplary embodiment, the first attribute may be determined by the user (e.g., by user selection) and remaining attributes may be assigned to a corresponding attribute at random. Alternatively, the user may define attributes to be associated with each axis. In an exemplary embodiment, the selected content item may not include a number of attributes or metadata tags assigned to the selected content item sufficient to enable the assignment of an attribute to each axis. As such, a randomly selected attribute may be associated with any axis or axes that do not have a corresponding attribute. Accordingly, randomness may be inserted into content browsing. As an alternative, the user may select to include a random feature or attribute assigned to at least one axis under all or particular circumstances in order to introduce an element of randomness into content searching or browsing. As yet another alternative, for example, if content items are displayed in a grid fashion and one or more axes are not completely full, e.g., due to a limited number of content items associated with the corresponding attribute of the axis, then randomly selected content items may fill in the spaces that would otherwise be empty.

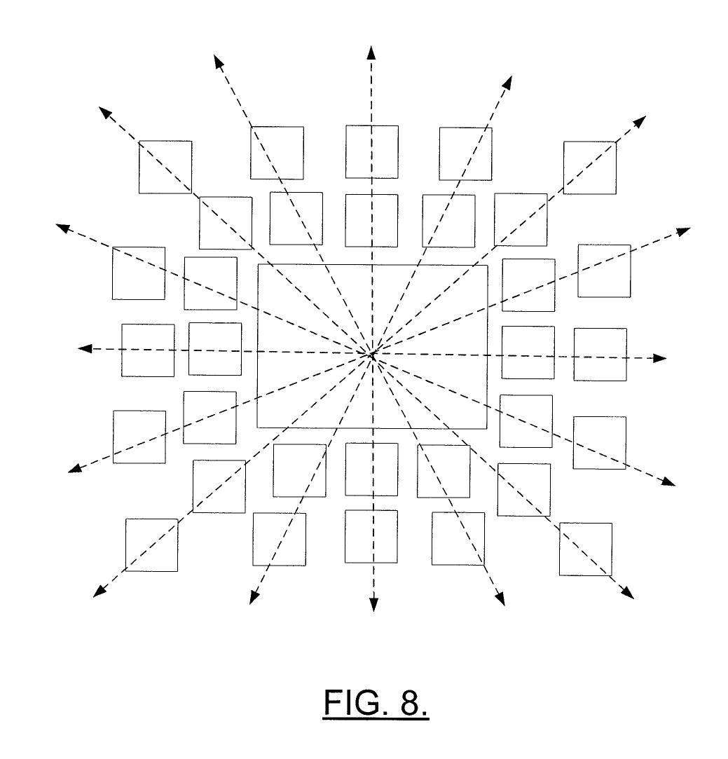

Although FIGS. 6 and 7 illustrate a three-by-three grid, grids of other sizes and including any number of axes may also be possible such as illustrated, for example, in FIG. 8. Additionally, as shown in FIG. 8, the currently selected content item could be displayed in an enlarged format with respect to other content items of the grid. In any of the FIGS. 4-8, rotation of the grid may be performed in accordance with user instructions. Such rotation could be, for example, in either a clockwise or counterclockwise direction around the currently selected content item, which may be displayed in the center of the grid. It should also be noted that, although FIGS. 4-8 illustrate a grid format in which the axes are linear, the axes need not necessarily be linear. Thus, for example, the axes could be curvilinear, helical or another shape such as arranging the content items in a spiral manner. Furthermore, the axes need not necessarily be laid out in two dimensions, but may be presented in more than two dimensions such as in a three dimensional (3D) arrangement with axes at least extending, for example, in X, Y, and Z directions. In one embodiment, the grid format may be determined based on size, popularity, play frequency, number of items, etc. Moreover, different axes within the same grid format may have different shapes. Additionally, as indicated below, other schemes, such as color schemes, may be utilized to differentiate content items in different groups.

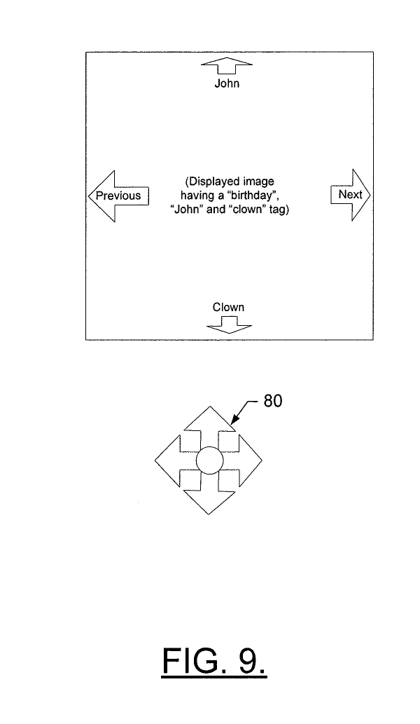

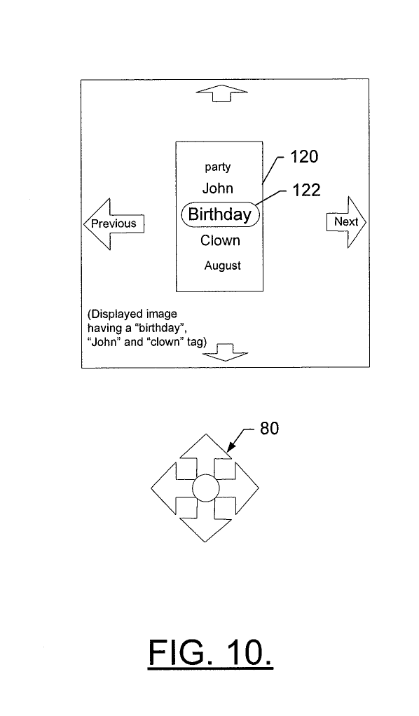

As discussed above, although FIGS. 4-8 illustrate a grid format for rendering or displaying content items, a content item may alternatively be rendered such that only the selected content item is displayed at any given time. As such, an arrangement of related content items may be determined, but only the selected content item may be displayed at any given time. FIGS. 9 and 10 illustrate examples of a display rendering a particular image in which a scrolling function may be initiated to access content related on the basis of, for example, a first or second attribute in accordance with an embodiment of the present invention.

In this regard, FIG. 9 illustrates an example in which the first attribute has been selected (e.g., “birthday”) and scrolling to the right or left (e.g., along the first axis) may trigger the display of a previous or next image sharing the “birthday” attribute. However, it should be noted that the words “previous” and/or “next” need not actually be displayed (e.g., instead a portion of the adjacent content item may be displayed without any text indicating which content item is next or previous. Meanwhile, scrolling along the second axis (e.g., up or down) may trigger the display of an image sharing a different attribute with a currently displayed image. In one embodiment, pressing the enter key or another key may cause a display of the tags associated with the content items displayed on the axes. As indicated above, scrolling along the second axis in either direction may lead to an image sharing a different attribute (e.g., “John”) with the currently displayed image. However, as an alternative, if, for example, the currently displayed image is a picture of a clown performing at John's birthday party, scrolling up could change to one different attribute (e.g., “John”), while scrolling down could change to another different attribute (e.g., “clown”) and scrolling along the first axis subsequent to selection of either different attribute may display other content items related to the newly selected content item on the basis of the corresponding different attribute, while scrolling along the second axis may enable changing of the attribute again. In other words, scrolling along a first axis may lead to the rendering of other content sharing a first attribute or theme with a currently displayed content item and scrolling along a second axis may cause a change in the attribute or theme to a second attribute or theme. In an exemplary embodiment, a long press or holding the scroll function for a predetermined period of time for scrolling along any axis may cause a higher rate of scrolling. Alternatively, the scroll speed may be proportional to the length of time the scroll function is applied. In an exemplary embodiment, content along a particular axis could be scrolled over in a continuous loop (e.g., with a marker indicating when the loop is being repeated) such that scrolling along the particular axis may give a next or previous content item associated with the feature corresponding to the particular axis. However, as alternative, scrolling along the particular axis may yield a next content item when scrolling in one direction (e.g., up or right), but scrolling in the opposite direction along the particular axis (e.g., down or left, respectively) may cause a change in feature or attribute.

In an exemplary embodiment, an attribute may comprise a similarity between images. Any known similarity algorithm may be used to determine similarity between images. Accordingly, for example, a first attribute may be a creator of a given image. Thus, scrolling along the first axis may enable the user to access other images captured by the creator of the given image. However, with respect to the given image, scrolling along the second axis may enable the user to access other similar images (e.g., sharing the attribute of similarity with respect to the given image) captured, for example, by another person. Thereafter, images captured by the other person may be accessed by scrolling along the first axis. In an exemplary embodiment, certain features of an image or video stream may be determined automatically, such as by optical character recognition, image analysis or other mechanisms. It should also be noted that the content items need not be of the same type. As such, the content items may not all be images. Rather, some could be images, while others may be video, data, documents or other types of content.

FIG. 10 illustrates another alternative in which, although scrolling along the first axis produces similar results to those described above with respect to scrolling along the first axis, scrolling along the second axis may enable the user to select the different attribute (e.g., the second attribute). In this regard, for example, if the user scrolls along the second axis, a listing of attributes 120 (e.g., attributes associated with the currently selected content item) may be displayed (e.g., in alphabetical, popularity, or some other order) in order to enable the user to select the second attribute. In an exemplary embodiment, the first attribute (e.g., “birthday”), which may be indicative of the current theme, may initially be displayed prominently in the list (e.g., larger or in the center of the list) and other attributes may be displayed above and below the first attribute such that one of the attributes may be selected by scrolling over a particular attribute (e.g., the second attribute) and selecting the attribute (e.g., using the five way scroller 80). While scrolling through the listing of attributes 120, a highlighted one of the attributes may be displayed more prominently in the center of the list, or a highlight or selection box 122 may be displayed to indicate which one of the attributes may be selected in response to an input of a selection command, for example, via the five way scroller 80. The listing of attributes 120 could also be presented in, for example, a corner of the screen, or another less prominent location, when a picture is view. Alternatively, the listing of attributes 120 may be dimmed or transparent so that part of an image below the listing of attributes 120 may be at least partially visible. As such, a click on an attribute may quickly enable a change to a new feature, attribute, subject or theme to be associated with the first axis. After the second attribute is selected, scrolling along the first axis may enable the user to access content items related to each other by sharing the second attribute. Additionally, selection of the second attribute may cause a rendering of a new content item related to the previously rendered content item on the basis of the second attribute. It may also be possible to freeze on a particular attribute until all content associated with the particular attribute has been viewed, at which time the user may be prompted to select another attribute or feature. The first and second attributes may be, for example, metadata associated with a content item, location information such as GPS coordinates or other location data associated with the content item, people in or creating the content item, time of creation of the content item (e.g., for chronological ordering), cell ID, context, user inserted textual tags, automated image/video recognition, rating, random features, or other attributes. In an exemplary embodiment, a lack of any metadata could also be considered a feature. Other possible features may include, for example, sharing only one attribute with other content items, sharing no attributes with other displayed content items, etc. As another alternative, image, audio and/or video analysis software may be employed to analyze which content items share particular attributes such as, e.g. similar bass and tempo in music, image recognition of objects in a photo, etc.

The content arranger 70 may be configured to access metadata and/or other attributes associated with each content item in a particular storage location (e.g., in a particular folder or portion of the memory device 72) to determine how to arrange each content item for display or rendering with respect to scrolling along any axis. Based on the characteristics of each content item with respect to the defined attributes, the content arranger 70 may provide information, for example, to the processing element 74 to enable display or rendering of the corresponding content items at a position of a grid or in an order defined by the respective metadata or attributes of each content item.

As suggested above, the axes need not be laid out in a linear fashion. Moreover, it should be understood that the axes need not be laid our in a two dimensional grid. Instead, for example, the axes could be provided in a three dimensional format. For example, a presence of axes that would extend into and/or out of the page at various different trajectories could be indicated by a symbol or an icon. A scroll function for accessing content in these “three dimensional axes” may be invoked by selection of a particular key, by voice command, an options menu, a pop-up window, a drop down menu, etc.

In an exemplary embodiment in which the user interface 76 is a touch screen, selection of content items and/or manipulation of the display or content being displayed may be performed in many different ways. For example, scrolling may be accomplished by selection of a content item and dragging the content item along a particular axis. Alternatively, scrolling may be accomplished by dragging the pointing device (e.g., finger, stylus, etc.) across the display or along a particular axis. Selection may be performed with regard to a single item (e.g., by touching the item) or of multiple items. In this regard, for example, multiple items could be selected at the same time by using the pointing device to draw a shape (e.g., a circle, rectangle, square, etc.) around the particular items that are to be included in the selection. As an alternative, multiple items could be selected by pressing several fingers on corresponding items at the same time. As yet another alternative, a particular key or menu option may be selected to indicate that items selected thereafter (e.g., by touching) are to be included in a set of multiple items. Such functionality may be similar to the selection of the control (CTRL) or shift keys on a PC to define several items for inclusion into a set or list. In this regard, the particular key or menu option may be used to provide mode shift functionality in which a shift may be enabled between a first mode (e.g., in which each touching of an item represents a selection of only the item most recently touched or items simultaneously touched) and a second mode (e.g., in which touching of each subsequent item adds the subsequent item to a set including previously touched items).

Selection of multiple items at the same time (regardless of how such selection is made) may define the selected items to share a particular attribute. Accordingly, the selected items could be displayed on a particular axis, with other related items (e.g., related via other attributes) may be displayed on corresponding other axes. In one embodiment, selection of an item or group of items and placement of such item(s) on a particular axis may cause the attribute associated with the particular axis to be added to the item or group of items.

In an exemplary embodiment, a content item or a metadata tag or tags associated with the content item may be deleted in response to the content item being dragged to the border of the screen. In this regard, for example, rather than deleting all metadata tags associated with the content item, only the metadata tag upon which the current display of the content item is based may be deleted. Thus, for example, if the content item is displayed on an axis sharing a particular attribute (e.g., “birthday”) and the content item is moved to the border of the screen, then according to one embodiment only the metadata tag associated with the particular attribute may be deleted. Meanwhile, for example, the deleted tag could be held in reserve for assignment to another content item (e.g., using another drag and drop operation). The touch screen may also enable zooming in and/or out with respect to a grid view and/or a view of a particular content item. In an exemplary embodiment, a subpart or subparts and/or an item or items within a particular content item could be selected for creation of a new grid of associated photos.

In an exemplary embodiment, although it may be possible to define a fixed number of axes (e.g., two axes for a two dimensional display), the number of axes presented may depend on (or even be equal to) the number of features defined for a currently selected content item. An orientation of multiple axes may depend upon, for example, user preferences defining a number of axes to be provided and/or which particular axes to provide as options for seamless theme changes during content viewing. As such, the user may utilize voice commands, an options menu, pop-up window, drop down menu, etc. to establish preferences for or otherwise direct the establishment of feature axes. Alternatively or additionally, a number and/or orientation of the axes may depend upon stored information such as a history of which features are most commonly used. In this regard, for example, the features most commonly used as the basis for sorting and/or viewing content could be placed on horizontal and/or vertical axes with respect to the selected content item. Meanwhile, less commonly used features may be oriented in diagonal axes or axes that extend in a third dimension. As yet another alternative, device capabilities (e.g., display size, navigation mechanism, etc.) may be used to determine a number of axes that may be provided.

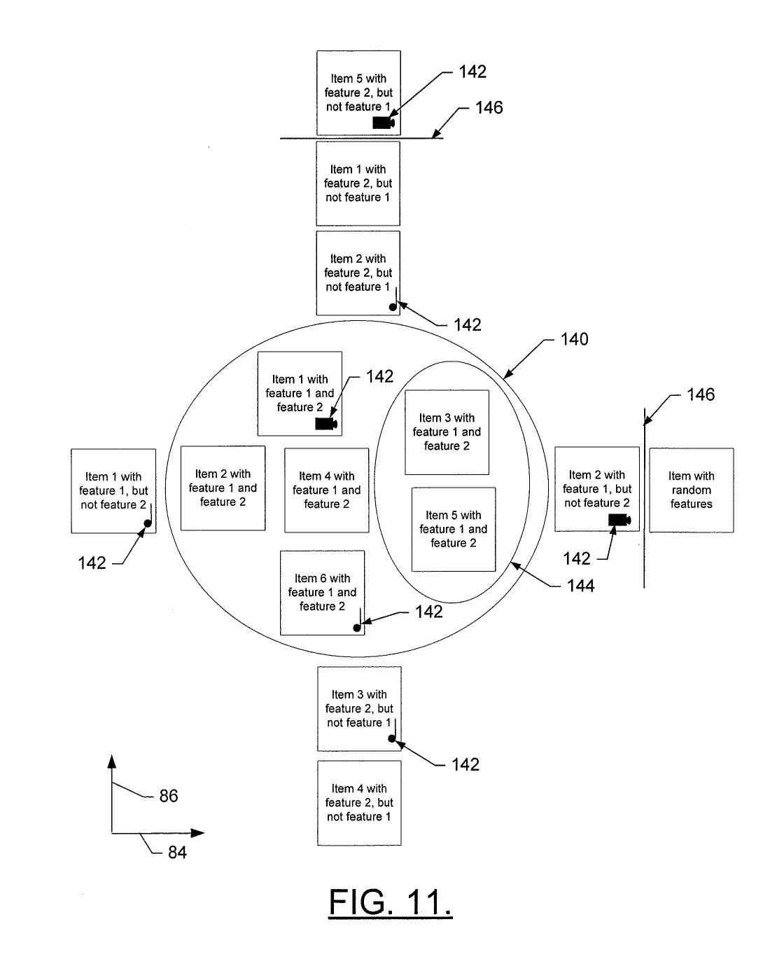

In another exemplary embodiment, as illustrated in FIG. 11, a content pool 140 may be defined along a particular axis or set of axes. In this regard, for example, if a plurality of content items share both of two particular features (e.g., the features corresponding to the first and second axes) then the content pool 140 may include all content items sharing the two particular features. Other content items sharing a first of the two particular features (but not a second of the two particular features) may then be arranged along the first axis, while other content items sharing the second of the two particular features (but not the first) may be arranged along the second axis. In an exemplary embodiment, items of the content pool 140 may be displayed in numerous different ways. For example, items of the content pool 140 may be displayed in a fish-eye/barrel way, as a grid, in a scattered format, etc.

Alternatively, rather than displaying content associated with a particular feature along an axis, the content may be displayed in a content pool 140 and content associated with other features may be displayed in other content pools. In this regard, for example, the content pools, which may be defined by lines that form a shape (e.g., circle, square, rectangle, etc.) or freeform lines, may overlap each other. As such, color schemes or other mechanisms may be employed to color boundaries of the content pools. Alternatively, rather than drawing boundaries around the content pools, items within a particular content pool may be displayed with an associated identifier such as an icon, a color border, border thickness, etc., in order to identify content that share the same features. Color backgrounds or borders may alternatively be used to indicate a central item within a circuit or an initially viewed item, with changes to the background and/or border being indicative of a distance from the center or initially viewed item.

In an exemplary embodiment in which content pools are employed, the scroll function may be used to jump between either content items or even between content pools. In this regard, the content pool itself may be considered a content item between which a scroll function may be performed to change from one theme (e.g., attribute or feature of interest) to another theme. Arrangements of content within a pool may further be provided on the basis of other tags or features, viewing frequency, or other attributes. Moreover, the content in a particular pool may have multiple shared attributes thereby enabling the creation of sub-pools within pools in which each sub-pool includes content within a pool that shares an additional common feature with respect to content of the next more general level of the pool. As stated above, the content items need not be of the same type. Accordingly, for example, additional information such as the identifier mentioned above may be provided to indicate the type of the content item (e.g., music, image, document, etc.). Moreover, the type of the content item could itself be a feature or attribute forming the basis for organization in accordance with embodiments of the present invention.

FIG. 11 also shows, as an example, an identifier 142 associated with particular ones of the content items of the content pool 140 indicating a type of content (in this case music files as indicated by a musical note and movies with a movie projector). A sub-pool 144 is also illustrated as an example indicating content items sharing a third feature within the content pool 140. Although content may be scrolled through in a circular fashion while scrolling in a particular direction (e.g., scrolling up may cause the display of content that was previously seen once all content associated with the feature associated with the axis of the scroll), it may be desirable to provide an indication of when content that has previously been provided is being encountered again. Accordingly, a barrier 146 may be provided to indicate when a circuit of scrolling with regard to a particular feature has been completed. For example, if a particular axis is ordered (e.g., in terms of time and/or date) the barrier 146 may prevent looping of content scrolling or allow continued scrolling but indicate that a circuit of the ordered content has been traversed. Additionally or alternatively, since randomness may be introduced into a search in accordance with embodiments of the present invention, the barrier 146 may define a transition from content associated with a particular feature to content associated with a random feature as also indicated in FIG. 11.

In some embodiments, due to content items sharing multiple different attributes, it may be possible that one content item may be accessible via scrolling over multiple different axes. In some cases, such a content item may appear multiple times within a displayed grid of content items. However, in an exemplary embodiment, a rule may be provided to ensure that each content item is displayed only one time within the grid. In this regard, for example, a content item that would otherwise be displayed multiple times may only be displayed along one axis (which could be determined by user preference or default rules).

Embodiments of the present invention may be useful for creating slideshows or pause screen/screen savers, etc., where an algorithm may navigate through the different axes and content items based on a level of “randomized” behavior that is desired. Additionally, in some embodiments, the profile (e.g., normal, silent, outdoor, meeting, etc.) of the mobile terminal 10 or other device employing embodiments of the present invention may be utilized to perform filter like functions with respect to content item rendering. For example, if in silent mode, then no audio files or video files may be shown. As another example, content items displayed may be based on Bluetooth (or other communication technologies) devices near the device employing embodiments of the present invention. Accordingly, picture or other content item sharing between individuals in proximity to each other may be enhanced. In such an embodiment, the Bluetooth name may be mapped to the metadata in the corresponding content items. Content items could also be displayed based on presence information in an instant messaging service/program. Accordingly, all online contacts may be shown along one axis, and so on. Alternatively, only content with relation to online/available people may be displayed along one axis, and content associated with people that are “away” or “N/A” may be displayed along other axes.

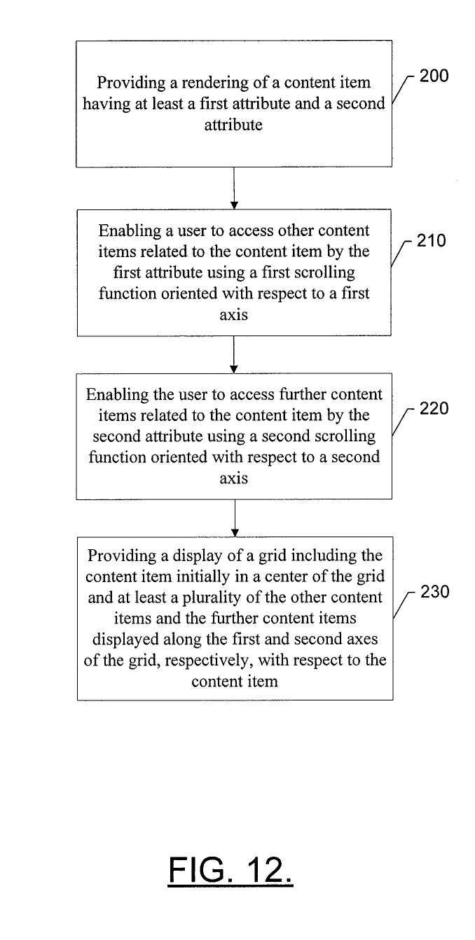

FIG. 12 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer- implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing presentation of content items of a media collection as illustrated, for example, in FIG. 12 may include providing for a rendering of a content item having at least a first attribute and a second attribute at operation 200. At operation 210, a user may be enabled to access other content items related to the content item by the first attribute using a first scrolling function oriented with respect to a first axis. The user may then be enabled to access further content items related to the content item by the second attribute using a second scrolling function oriented with respect to a second axis at operation 220. In an exemplary embodiment, the method may further include providing a display of a grid including the content item initially in a center of the grid and at least a plurality of the other content items and the further content items displayed along the first and second axes of the grid, respectively, with respect to the content item at operation 230.

In an exemplary embodiment, enabling the user to access the other content items may include providing the first scrolling function to scroll between a plurality of content items that each share the first attribute, and enabling the user to access the further content items may include providing the second scrolling function to scroll between a plurality of content items that each share the second attribute on the second axis being substantially perpendicular to the first axis. The first scrolling function or the second scrolling function may be performed in response to receiving an input indicative of execution of a scroll function via a user interface such as a directional scroller. Operation 220 may include, in one embodiment, providing the second scrolling function to scroll through a plurality of attributes associated with the content item in order to select the second attribute.

In an exemplary embodiment, operation 230 may include providing at least a third axis along which a third scroll function enables selection of additional content items related to the content item based on a third attribute. Alternatively or additionally, after one of the first and second scroll functions are used to select a new content item among the other content items or the further content items, items displayed in the grid may be updated based on attributes associated with the new content item. In another example, operation 230 may include providing a display of a plurality of additional content items on a plurality of corresponding axes in which each of the corresponding axes corresponds to one of a plurality of attributes and at least one of the plurality of attributes is selected at random and is not related to the content item. In still another example, operation 230 may further include providing a plurality of additional content items in additional columns or rows that extend substantially parallel to the first axis in which the additional content items of each corresponding additional column or row of the grid are related to each other on the basis of a different attribute.

In an exemplary embodiment, operation 200 may include displaying a single content item comprising image data having the first and second attributes comprising a first metadata tag and a second metadata tag, respectively, in which enabling the user to access the other content items related to the content item by the first attribute using the first scrolling function includes providing an indicator indicative of a directional input configured to provide another image related to the content item based on sharing the first metadata tag. In this regard, sharing a metadata tag could imply sharing an exact same metadata tag. However, in an exemplary embodiment, sharing a metadata tag may not imply identical tags, but tags that are similar or geographically and/or temporally proximate. Additionally, enabling the user to access the further content items related to the content item by the second attribute using the second scrolling function may include providing a different indicator indicative of a different directional input configured to provide a further image related to the content item based on sharing the second metadata tag.

In an exemplary embodiment, the first attribute is selected by the user and the second attribute is randomly selected or selected by the user. Providing the rendering of the content item may include providing rendering of at least one of video data, image data, and audio data, and wherein the first and second attributes comprise a first metadata tag and a second metadata tag, respectively.

It should be noted that although exemplary embodiments discuss content, the content may include objects or items such as, without limitation, image related content items, video files, television broadcast data, text, documents, web pages, web links, audio files, radio broadcast data, broadcast programming guide data, location tracklog information, etc.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing for a rendering of a content item having at least a first attribute and a second attribute;
enabling a user to access other content items related to the content item by the first attribute using a first scrolling function oriented with respect to a first axis; and
enabling the user to access further content items related to the content item by the second attribute using a second scrolling function oriented with respect to a second axis.

2. A method according to claim 1, wherein enabling the user to access the other content items comprises providing the first scrolling function to scroll between a plurality of content items that each share the first attribute, and wherein enabling the user to access the further content items comprises providing the second scrolling function to scroll between a plurality of content items that each share the second attribute on the second axis being substantially perpendicular to the first axis.

3. A method according to claim 1, wherein enabling the user to access the further content items comprises providing the second scrolling function to scroll through a plurality of attributes associated with the content item in order to select the second attribute.

4. A method according to claim 1, further comprising providing a display of a grid including the content item initially in a center of the grid and at least a plurality of the other content items and the further content items displayed along the first and second axes of the grid, respectively, with respect to the content item.

5. A method according to claim 4, wherein providing the display of the grid further comprises providing at least a third axis along which a third scroll function enables selection of additional content items related to the content item based on a third attribute.

6. A method according to claim 4, wherein, after one of the first and second scroll functions are used to select a new content item among the other content items or the further content items, updating items displayed in the grid based on attributes associated with the new content item.

7. A method according to claim 4, further comprising providing a display of a plurality of additional content items on a plurality of corresponding axes in which each of the corresponding axes corresponds to one of a plurality of attributes and at least one of the plurality of attributes is selected at random and is not related to the content item.

8. A method according to claim 7, further comprising providing the plurality of corresponding axes in a three dimensional structure.

9. A method according to claim 4, further comprising providing a plurality of additional content items in additional columns or rows that extend substantially parallel to the first axis in which the additional content items of each corresponding additional column or row of the grid are related to each other on the basis of a different attribute.

10. A method according to claim 1, wherein providing for the rendering of the content item comprises displaying a single content item comprising image data having the first and second attributes comprising a first metadata tag and a second metadata tag, respectively, wherein enabling the user to access the other content items related to the content item by the first attribute using the first scrolling function comprises providing an indicator indicative of a directional input configured to provide another image related to the content item based on sharing the first metadata tag, and wherein enabling the user to access the further content items related to the content item by the second attribute using the second scrolling function comprises providing a different indicator indicative of a different directional input configured to provide a further image related to the content item based on sharing the second metadata tag.

11. A method according to claim 1, further comprising receiving an input indicative of execution of the first scrolling function or the second scrolling function via a user interface comprising a directional scroller.

12. A method according to claim 1, further comprising selecting the first and second attributes, wherein first attribute is selected by the user and wherein the second attribute is randomly selected or selected by the user.

13. A method according to claim 1, wherein providing the rendering of the content item comprises providing rendering of at least one of video data, image data, and audio data, and wherein the first and second attributes comprise a first metadata tag and a second metadata tag, respectively.

14. A computer program product comprising at least one computer-readable storage medium having computer-readable program code portions stored therein, the computer-readable program code portions comprising:
a first executable portion for providing for a rendering of a content item having at least a first attribute and a second attribute;
a second executable portion for enabling a user to access other content items related to the content item by the first attribute using a first scrolling function oriented with respect to a first axis; and
a third executable portion for enabling the user to access further content items related to the content item by the second attribute using a second scrolling function oriented with respect to a second axis.

15. A computer program product according to claim 14, wherein the second executable portion includes instructions for providing the first scrolling function to scroll between a plurality of content items that each share the first attribute, and wherein the third executable portion includes instructions for providing the second scrolling function to scroll between a plurality of content items that each share the second attribute on the second axis being substantially perpendicular to the first axis.

16. A computer program product according to claim 14, wherein the third executable portion includes instructions for providing the second scrolling function to scroll through a plurality of attributes associated with the content item in order to select the second attribute.

17. A computer program product according to claim 14, further comprising a fourth executable portion for providing a display of a grid including the content item initially in a center of the grid and at least a plurality of the other content items and the further content items displayed along the first and second axes of the grid, respectively, with respect to the content item.

18. A computer program product according to claim 17, wherein the fourth executable portion includes instructions for providing at least a third axis along which a third scroll function enables selection of additional content items related to the content item based on a third attribute.

19. A computer program product according to claim 17, wherein the fourth executable portion includes instructions for, after one of the first and second scroll functions are used to select a new content item among the other content items or the further content items, updating items displayed in the grid based on attributes associated with the new content item.

20. A computer program product according to claim 17, further comprising a fifth executable portion for providing a display of a plurality of additional content items on a plurality of corresponding axes in which each of the corresponding axes corresponds to one of a plurality of attributes and at least one of the plurality of attributes is selected at random and is not related to the content item.

21. A computer program product according to claim 20, further comprising a sixth executable portion for providing the plurality of corresponding axes in a three dimensional structure.

22. A computer program product according to claim 17, further comprising a fifth executable portion for providing a plurality of additional content items in additional columns or rows that extend substantially parallel to the first axis in which the additional content items of each corresponding additional column or row of the grid are related to each other on the basis of a different attribute.

23. A computer program product according to claim 14, wherein the first executable portion includes instructions for displaying a single content item comprising image data having the first and second attributes comprising a first metadata tag and a second metadata tag, respectively, wherein the second executable portion includes instructions for providing an indicator indicative of a directional input configured to provide another image related to the content item based on sharing the first metadata tag, and wherein the third executable portion includes instructions for providing a different indicator indicative of a different directional input configured to provide a further image related to the content item based on sharing the second metadata tag.

24. A computer program product according to claim 14, further comprising a fourth executable portion for receiving an input indicative of execution of the first scrolling function or the second scrolling function via a user interface comprising a directional scroller.

25. A computer program product according to claim 14, further comprising a fourth executable portion for selecting the first and second attributes, wherein first attribute is selected by the user and wherein the second attribute is randomly selected or selected by the user.

26. A computer program product according to claim 14, wherein the first executable portion includes instructions for providing rendering of at least one of video data, image data, and audio data, and wherein the first and second attributes comprise a first metadata tag and a second metadata tag, respectively.

27. An apparatus comprising a processing element configured to:
provide for a rendering of a content item having at least a first attribute and a second attribute;
enable a user to access other content items related to the content item by the first attribute using a first scrolling function oriented with respect to a first axis; and
enable the user to access further content items related to the content item by the second attribute using a second scrolling function oriented with respect to a second axis.

28. An apparatus according to claim 27, wherein the processing element is further configured to provide the first scrolling function to scroll between a plurality of content items that each share the first attribute, and to provide the second scrolling function to scroll between a plurality of content items that each share the second attribute on the second axis being substantially perpendicular to the first axis.

29. An apparatus according to claim 27, wherein the processing element is further configured to provide the second scrolling function to scroll through a plurality of attributes associated with the content item in order to select the second attribute.

30. An apparatus according to claim 27, wherein the processing element is further configured to provide a display of a grid including the content item initially in a center of the grid and at least a plurality of the other content items and the further content items displayed along the first and second axes of the grid, respectively, with respect to the content item.

31. An apparatus according to claim 30, wherein the processing element is further configured to provide at least a third axis along which a third scroll function enables selection of additional content items related to the content item based on a third attribute.

32. An apparatus according to claim 30, wherein the processing element is further configured to provide that, after one of the first and second scroll functions are used to select a new content item among the other content items or the further content items, items displayed in the grid are updated based on attributes associated with the new content item.

33. An apparatus according to claim 30, wherein the processing element is further configured to provide a display of a plurality of additional content items on a plurality of corresponding axes in which each of the corresponding axes corresponds to one of a plurality of attributes and at least one of the plurality of attributes is selected at random and is not related to the content item.

34. An apparatus according to claim 33, wherein the processing element is further configured to provide the plurality of corresponding axes in a three dimensional structure.

35. An apparatus according to claim 30, wherein the processing element is further configured to provide a plurality of additional content items in additional columns or rows that extend substantially parallel to the first axis in which the additional content items of each corresponding additional column or row of the grid are related to each other on the basis of a different attribute.

36. An apparatus according to claim 27, wherein the processing element is further configured to display a single content item comprising image data having the first and second attributes comprising a first metadata tag and a second metadata tag, respectively, to provide an indicator indicative of a directional input configured to provide another image related to the content item based on sharing the first metadata tag, and to provide a different indicator indicative of a different directional input configured to provide a further image related to the content item based on sharing the second metadata tag.

37. An apparatus according to claim 27, wherein the processing element is further configured to receive an input indicative of execution of the first scrolling function or the second scrolling function via a user interface comprising a directional scroller.

38. An apparatus according to claim 27, wherein the processing element is further configured to receive a selection of the first and second attributes, wherein first attribute is selected by the user and wherein the second attribute is randomly selected or selected by the user.

39. An apparatus according to claim 27, wherein the processing element is further configured to provide rendering of at least one of video data, image data, and audio data, and wherein the first and second attributes comprise a first metadata tag and a second metadata tag, respectively.

40. An apparatus comprising:
means for providing for a rendering of a content item having at least a first attribute and a second attribute;
means for enabling a user to access other content items related to the content item by the first attribute using a first scrolling function oriented with respect to a first axis; and
means for enabling the user to access further content items related to the content item by the second attribute using a second scrolling function oriented with respect to a second axis.

41. An apparatus according to claim 40, further comprising means for providing a display of a grid including the content item initially in a center of the grid and at least a plurality of the other content items and the further content items displayed along the first and second axes of the grid, respectively, with respect to the content item.

42. A system comprising:
a first device comprising a storage device and a corresponding first processing element, the storage device storing a plurality of content items, wherein at least one of the content items has a first attribute and a second attribute associated therewith and some other ones of the content items share the first attribute or the second attribute; and
a second device in communication with the first device, the second device including at least a corresponding second processing element, the second processing element being configured to receive at least a representation of a portion of the content items and the attributes corresponding to each content item of the portion of the content items, the second processing element being further configured to:
provide for a rendering of representation and corresponding attributes,
enable a user to access other content items related to the content item including the first attribute using a first scrolling function oriented with respect to a first axis, and
enable the user to access further content items related to the content item by the second attribute using a second scrolling function oriented with respect to a second axis.

43. A user interface comprising:
a display for rendering of a content item having at least a first attribute and a second attribute; and
an input interface configured to receive a user input to enable the user to access other content items related to the content item by the first attribute using a first scrolling function oriented with respect to a first axis, and enable the user to access further content items related to the content item by the second attribute using a second scrolling function oriented with respect to a second axis.
